(19) United States
(12) Patent Application Publication
(10) Pub. No.: US 2007/0230201 A1
(43) Pub. Date: Oct. 4, 2007

(54) Outside door handle for vehicle

(75) Inventors: Tatsuya Oba, Aichi-ken (JP); Tetsuya Fujii, Aichi-ken (JP); Chiharu Totani, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-Ken (JP)

(21) Appl. No.: 11/723,969

(22) Filed: Mar. 22, 2007

(30) Foreign Application Priority Data
Mar. 22, 2006 (JP) 2006-078327

(51) Int. Cl. B60Q 1/26

(52) U.S. Cl. 362/501

(57) ABSTRACT

An outside door handle for a vehicle includes a handle main body provided on an outer surface of a vehicle door. The handle main body is formed of a transparent material. A light emitting member is embedded in the handle main body. Electricity required for permitting the light emitting member to emit light is wirelessly supplied from the outside of the handle main body. The outside door handle thus prevents the wiring from being complex.

### BACKGROUND OF THE INVENTION

The present invention relates to an outside door handle for a vehicle, and more particularly, to an outside door handle capable of functioning as display means.

In a vehicle equipped with a keyless entry system, the doors and the trunk are locked and unlocked automatically. For example, Japanese Laid-Open Patent Publication No. 2005-161904 discloses a keyless entry system in which light emitting means is provided in an outside door handle of a vehicle. The light emitting means operates, in response to a signal from the outside of the vehicle, to indicate whether the door is locked or unlocked. The light emitting means is, for example, formed of LEDs, and receives electricity from an external power source through wiring.

However, since a door lock actuator, an antenna, and transceiving means are located in the vicinity of the outside door handle, the installment of the light emitting means complicates the wiring. Further, waterproof treatment needs to be applied for preventing the wiring that connects the external power source to the light emitting means from being wet with rain water and car wash water. In the case where a transparent material is used for forming the entire outside door handle, the appearance of the outside door handle will be degraded if no measures are taken for diminishing the appearance of the wiring.

### SUMMARY OF THE INVENTION

Accordingly, it is an objective of the present invention to provide an outside door handle for a vehicle that prevents the wiring from being complicated.

In accordance with one aspect of the present invention, an outside door handle for a vehicle including a handle main body and a light emitting member is provided. The handle main body is provided on an outer surface of a vehicle door and is formed of a transparent material. The light emitting member is embedded in the handle main body. Electricity required for permitting the light emitting member to emit light is wirelessly supplied from the outside of the handle main body.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a schematic perspective view illustrating an outside door handle according to one embodiment of the present invention;

FIG. 1B is a schematic cross-sectional view illustrating the relationship between an light emitting diode and a contactless induction power source of the outside door handle shown in FIG. 1A;

FIG. 2 is a block diagram showing the entire configuration of a keyless entry system;

FIG. 3 is a circuit diagram showing a power transmission section and a power reception section of the keyless entry shown in FIG. 2; and

FIGS. 4A and 4B are circuit diagrams showing an operation of the power reception section shown in FIG. 3.

### DETAILED DESCRIPTION OF THE PREFERRED EMBODIMENTS

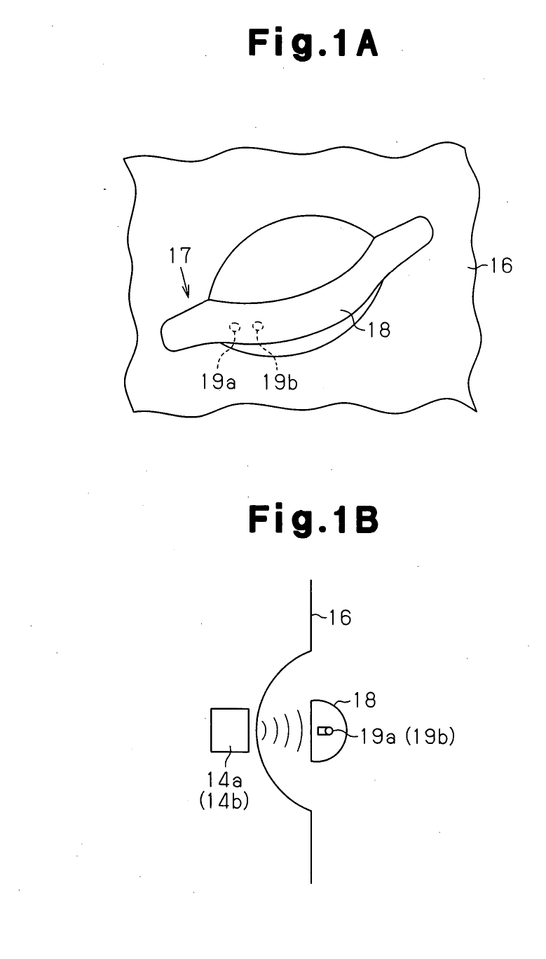

One embodiment of the present invention will now be described with reference to FIGS. 1A to 4B.

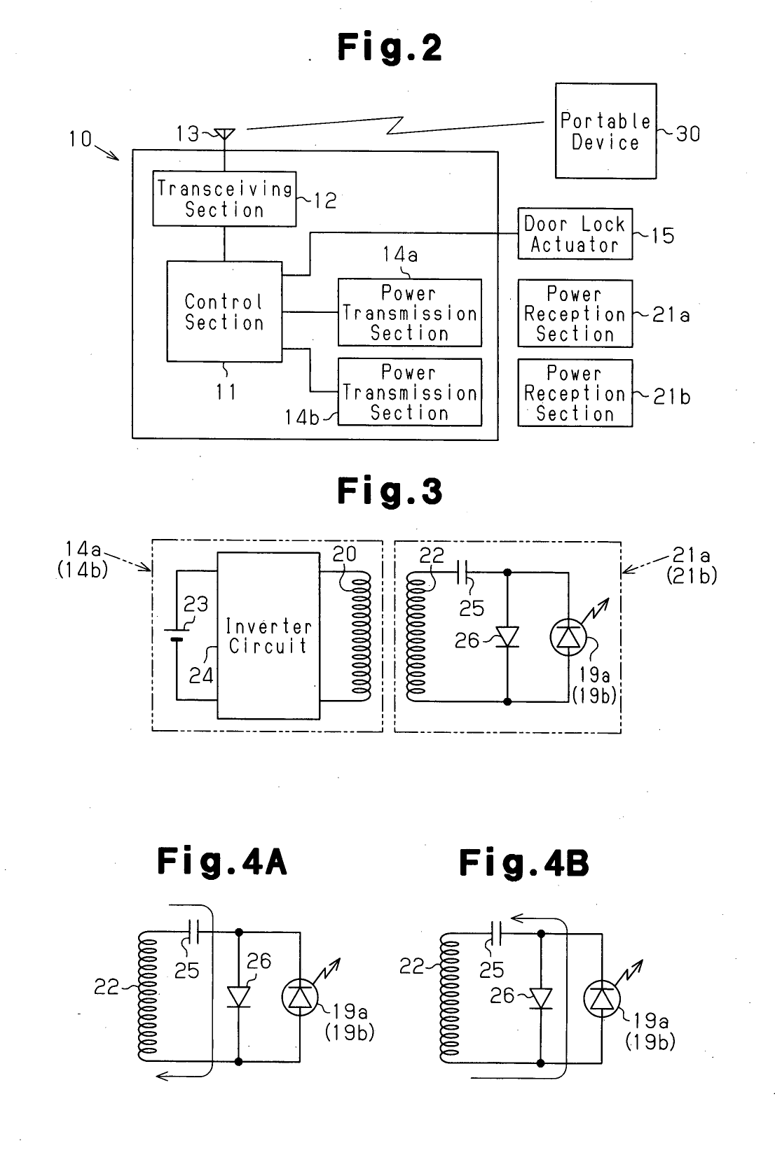

As shown in FIG. 2, a keyless entry system includes a main body device 10 mounted on a vehicle and a portable device 30 carried by a user. The main body device 10 includes a control section 11, a transceiving section 12, an antenna 13, and power transmission sections 14a, 14b. The control section 11 has a microcomputer (not shown), and controls the entire main body device 10, the power transmission sections 14a, 14b, and a door lock actuator 15. The control section 11 communicates with the portable device 30 by means of the transceiving section 12 and the antenna 13, and controls the door lock actuator 15 in accordance with the communication results with the portable device 30, thereby selectively locking and unlocking the door 16.

As shown in FIG. 1A, an outside door handle 17 is provided on the outer surface of the vehicle door 16. The outside door handle 17 includes a handle main body 18, in which two light emitting members, or two light emitting diodes 19a, 19b, are provided. In order that whether the door 16 is locked or unlocked is distinguished according to the color of emitted light from the outside door handle 17, the light emitting diodes 19a, 19b are of different colors. In this embodiment, the light emitting diode 19a is a red LED and emits red light when the door 16 is unlocked. The light emitting diode 19b is a blue LED and emits blue light when the door 16 is locked.

The handle main body 18 is formed of a transparent material. As shown in FIG. 1B, the handle main body 18 substantially has a semicircular cross-section with a flat surface facing the door 16. The light emitting diodes 19a, 19b are embedded in the handle main body 18 to be located near a longitudinal end of the handle main body 18, and substantially at the center with respect to a direction perpendicular to the longitudinal direction of the handle main body 18. When the door lock actuator 15 is shifted to an unlocked state, the door 16 is allowed to be opened by simply pulling the handle main body 18. The handle main body 18 is configured to be immovable relative to the door 16.

The electricity required for permitting the light emitting diodes 19a, 19b to emit light is wirelessly supplied from the outside of the handle main body 18. A contactless power transfer system is employed in this embodiment. Specifically, as shown in FIG. 3, the power transmission sections 14a, 14b in the main body device 10 each include a primary coil 20. Power reception sections 21a, 21b each including a secondary coil 22 are provided in the handle main body 18. Electricity is supplied through magnetic coupling between each primary coil 20 and the corresponding secondary coil 22.

As shown in FIG. 3, the power transmission sections 14a, 14b each have an external power source, which is a battery 23, and an inverter circuit 24, and the primary coil 20. When the inverter circuit 24 receives a control signal from the control section 11, an alternating current of a predetermined frequency (for example, 125 kHz) flows through the primary coil 20.

As shown in FIG. 3, each of the power reception sections 21a, 21b has the secondary coil 22, a capacitor 25, and a diode 26, which are connected in series, and the light emitting diode 19a, 19b, which is connected in antiparallel to the diode 26. Specifically, the cathode of the diode 26 is connected to the anode of the light emitting diode 19a, 19b, and the anode of the diode 26 is connected to the cathode of the light emitting diode 19a, 19b. The pair of the power transmission section 14a and the power reception section 21a and the pair of the power transmission section 14b and the power reception section 21b have essentially the same construction except for the capacities of the capacitors 25. Each pair corresponds to one of the light emitting diodes 19a, 19b. Each of the power reception sections 21a, 21b is mounted on a substrate and modularized, and embedded in the handle main body 18 through insert molding. That is, the secondary coils 22 connected to the light emitting diodes 19a, 19b are embedded in the handle main body 18 so as to be magnetically connectable with the primary coils 20 serving as a contactless induction power source located outside the handle main body 18. Each of the primary coils 20 and the secondary coils 22 is wound about a core (not shown). For example, ferrite cores are used.

In the manufacture of the handle main body 18, insert molding is performed in two stages such that whole modules formed of the power reception sections 21a, 21b and the substrates are not exposed from the handle main body 18. For example, in a first step, a half of the handle main body 18 is molded such that parts of the modules are exposed. Then, in a second step, the remainder of the handle main body 18 is molded so that the entire modules are not exposed from the handle main body 18. For example, an epoxy resin is used as a resin for forming the handle main body 18.

The operation of the outside door handle 17, which is constructed as above, will hereafter be described.

When a door unlock signal transmitted from the portable device 30 is received by the transceiving section 12 by means of the antenna 13, if the received signal is valid, the control section 11, based on the signal, outputs an unlock signal to the door lock actuator 15 for unlocking the door 16. That is, the door lock actuator 15 is activated by the unlock signal and unlocks the door 16. Thereafter, when confirming that the door 16 is unlocked by means of a sensor (not shown), the control section 11 outputs an activation signal to the power transmission section 14a to turn on the red light emitting diode 19a. As a result, the inverter circuit 24 of the power transmission section 14a is subjected to switching control at a predetermined frequency, so that an alternating current of a predetermined frequency (125 kHz) flows through the primary coil 20 of the power transmission section 14a.

When the alternating current flows through the primary coil 20 of the power transmission section 14a, magnetic fluxes generated by the flowing current induces an electromotive force in the secondary coil 22 of the power reception section 21a. The electromotive force corresponds to the direction of the current in the primary coil 20. Accordingly, electricity is supplied to the light emitting diode 19a. Specifically, in a state where an electromotive force is induced in such a manner that a current is generated flowing through the secondary coil 22 from the lower side to the upper side as viewed in FIG. 4A, the current does not flow through the light emitting diode 19a, but flows through the capacitor 25 and the diode 26. In this state, the light emitting diode 19a does not emit light, and the capacitor 25 is charged (electrostatic energy is stored).

On the other hand, when the direction of the current through the primary coil 20 is inverted, and an electromotive force is induced in such a manner that a current is generated flowing through the secondary coil 22 from the upper side to the lower side as viewed in FIG. 4B, the current flows through the light emitting diode 19a. At this time, the capacitor 25 discharges electricity, and the current caused by the discharge flows in the same direction as the current generated by the electromotive force. When a current flows through the light emitting diode 19a, the light emitting diode 19a emits red light. In this manner, the light emitting diode 19a blinks at a frequency that corresponds to the frequency of the alternating current flowing through the primary coil 20. To the human eye, the light emitting diode 19a seems to be continuously emitting light. When seeing that the handle main body 18 is glowing in red, the user easily recognizes that the door 16 has been unlocked.

When a door lock signal transmitted from the portable device 30 is received by the transceiving section 12 by means of the antenna 13 in the state where the door 16 is unlocked, if the received signal is valid, the control section 11, based on the signal, outputs a lock signal to the door lock actuator 15 for locking the door 16. That is, the door lock actuator 15 is activated by the lock signal and locks the door 16. Thereafter, when confirming that the door 16 is locked by means of the sensor (not shown), the control section 11 outputs an activation signal to the power transmission section 14b to turn on the blue light emitting diode 19b. As a result, the inverter circuit 24 of the power transmission section 14b is subjected to switching control at a predetermined frequency, so that an alternating current of a predetermined frequency (125 kHz) flows through the primary coil 20 of the power transmission section 14b.

As in the above described case of the red light emitting diode 19a, when the alternating current flows through the primary coil 20 of the power transmission section 14b, an electromotive force that corresponds to the direction of the current in the primary coil 20 is induced in the secondary coil 22 of the power reception section 21b, so that electricity is supplied to the light emitting diode 19b. This turns on the light emitting diode 19b. When seeing that the handle main body 18 is glowing in blue by the light of the light emitting diode 19b, the user easily recognizes that the door 16 has been locked.

The control section 11 stops outputting the activation signal to the power transmission sections 14a, 14b when a predetermined time has elapsed from the start of the outputting. The predetermined time is set to a sufficient period for the user to find out the light of the light emitting diode 19a, 19b, and is, for example, several tens of seconds. Thus, electricity is not wasted due to excessively extended lighting of the light emitting diodes 19a, 19b.

When finding out whether the door 16 is locked, the user transmits a lock verification signal from the portable device 30. When the lock verification signal is received by the transceiving section 12 by means of the antenna 13, if the received signal is valid, the control section 11 determines whether the door 16 is locked based on a signal from the sensor that detects the locking state of the door 16. When determining that the door 16 is locked, the control section 11 outputs an activation signal to the power transmission section 14b. When determining that the door 16 is not locked, the control section 11 outputs an activation signal to the power transmission section 14a. As a result, if the door 16 is locked, the blue light emitting diode 19b emits light for a predetermined period to cause the handle main body 18 to glow in blue. If the door 16 is not locked, the light emitting diode 19a emit light for a predetermined period to cause the handle main body 18 to glow in red. Thus, the user can find out whether the door 16 is locked by checking the color of the handle main body 18.

This embodiment provides the following advantages.

The handle main body 18 of the outside door handle 17 is formed of a transparent material, and the light emitting diodes 19a, 19b are embedded in the handle main body 18. The electricity required for permitting the light emitting diodes 19a, 19b to emit light is wirelessly supplied from the outside of the handle main body 18. Therefore, no wiring for connecting the light emitting diodes 19a, 19b to an external power source is required. Thus, even if no waterproof treatment is applied, the durability of the light emitting diodes 19a, 19b is not affected by rain water and car wash water. Also, since the light emitting members (the light emitting diodes 19a, 19b) are located inside the transparent handle main body 18 without wiring, the outside door handle 17 has a novel appearance.

The secondary coils 22 connected to the light emitting diodes 19a, 19b are embedded in the handle main body 18 so as to be magnetically connectable with the primary coils 20 serving as a contactless induction power source located outside the handle main body 18. The current flowing through the primary coil 20 located outside the handle main body 18 generates magnetic fluxes, which, in turn, induce electromotive force in the secondary coil 22 embedded in the handle main body 18 so that electricity is supplied to the light emitting diodes 19a, 19b. Since electromagnetic induction is used for supplying electricity wirelessly, the manufacture of the outside door handle 17 is simplified, and the reliability of the operation of the outside door handle 17 is improved.

Since the light emitting diodes 19a, 19b are used as light emitting members, high brightness is achieved by a low electric power. Further, since light emitting diodes of different colors emit light when the door 16 is locked and when the door 16 is unlocked, it is easy to find out whether the door 16 is locked or unlocked.

The light emitting diodes 19a, 19b, which indicate that the door 16 is locked or unlocked, emits light only for a predetermined period. Therefore, compared to a configuration in which a light emitting diode keeps emitting light throughout the period in which a door is locked or unlocked, the above embodiment prevents the amount of wasted electricity.

The light emitting diodes 19a, 19b are located near an end in the longitudinal direction of the handle main body 18. Therefore, compared to a configuration in which light emitting diodes are located in a center with respect to the longitudinal direction of the handle main body 18, the distance between the primary coil 20 and the secondary coil 22 can be shortened. This allows electromagnetic induction to be efficiently performed.

When the door lock actuator 15 is shifted to an unlocked state, the door 16 is allowed to be opened by simply pulling the handle main body 18. Therefore, no member for unlocking the door 16 needs to be provided on the handle main body 18, and the handle main body 18 does not need to be movable relative to the door 16. This simplifies the structure of the outside door handle 17 and adds to the flexibility of design.

In each of the power reception sections 21a, 21b, the light emitting diode 19a, 19b and the diode 26 are connected in antiparallel. Therefore, when an alternating current flows through the secondary coil 22 in response to an alternating current flowing through the primary coil 20, breakdown is prevented from occurring in the light emitting diodes 19a, 19b.

In the power reception sections 21a, 21b, the capacitor 25 is arranged such that, when a current flows through the diode 26, the capacitor 25 is charged. Therefore, the current generated when the capacitor 25 discharges electricity contributes to the light emitting of the light emitting diodes 19a, 19b. Thus, compared to the case where the capacitor 25 is not provided, the intensity of light emitted by the light emitting diodes 19a, 19b is increased for the same electromotive force.

The above embodiment may be modified as follows.

The colors of the light emitting diodes 19a, 19b are not limited to red and blue, but may be any combination of different colors.

The number of the light emitting members provided in the handle main body 18 is not limited to two, but may be one or more than two. In the case of one light emitting member, the light emitting state needs to be different when the door 16 is unlocked and when the door 16 is locked. For example, the light emitting member may blink when the door 16 is unlocked, and may continuously emit light when the door 16 is locked. In the case of three light emitting members of different colors, for example, two of them may be used for indicating locking and unlocking states of the door 16, and the other one may be used for indicating that the trunk is unlocked.

The light emitting diodes 19a, 19b may be of the same color. In this case, the number of the light emitting diodes 19a, 19b that emit light needs to be different when the door 16 is unlocked and when the door 16 is locked. For example, when the door 16 is unlocked, both the light emitting diodes 19a, 19b may emit light, and when the door 16 is locked, one of the light emitting diodes 19a, 19b may emit light.

The light emitting diodes 19a, 19b do not need to be closely arranged. That is, the distance between the light emitting diodes 19a, 19b may be changed as necessary.

The capacitor 25 provided in each of the power reception section 21a, 21b does not need to be connected between the secondary coil 22 and the anode of the diode 26, but may be connected between the secondary coil 22 and the cathode of the diode 26. This configuration has the same advantages as the illustrated embodiment.

As long as an alternating current is supplied to the primary coil 20, the capacitors 25 in the power reception sections 21a, 21b may be omitted. Both the capacitors 25 and the diodes 26 may be omitted.

The power transmission sections 14a, 14b do not need to be configured such that the inverter circuit 24 supplies an alternating current to the primary coil 20, but the inverter circuit 24 may be omitted. In this case, a switching element and the primary coil 20 are connected in series with the battery 23. The control section 11 switches the switching element such that a current in one direction is intermittently supplied to the primary coil 20. The capacitor 25 and the diode 26 of each of the power reception sections 21a, 21b are omitted, and the secondary coil 22 and the light emitting diode 19a, 19b are connected in series so that a current generated by the induced electromotive force in the secondary coil 22 flows from the anode to the cathode of the light emitting diodes 19a, 19b.

The frequency of switching of the switching element used for supplying a current to the primary coil 20 of the power transmission section 14a, 14b does not need to be 125 kHz, but may be any other value.

Instead of providing the battery 23 in each of the power transmission sections 14a, 14b, a common battery may be provided for both the power transmission sections 14a, 14b.

The handle main body 18 may be, like a conventional door handle, movable relative to the door 16. In a configuration where the handle main body 18 is movable relative to the door 16, if light emitting members that receives electricity from an external power source through wiring are embedded in the handle main body 18, relative movement of the handle main body 18 applies load on the wiring. This degrades the durability of the light emitting members. However, in the case of the present invention, no wiring is provided for supplying electricity to the light emitting members. Thus, even if the handle main body 18 moves relative to the door 16, the durability of the light emitting members is hardly affected.

The present invention is not limited to the outside door handle 17 for a side door, but may be applied to an outside door handle of a hatchback door.

Instead of the light emitting diodes 19a, 19b, electroluminescent elements may be used as light emitting members.

Instead of using the light emitting diodes 19a, 19b for indicating whether the door 16 is unlocked or locked, the light emitting diodes 19a, 19b may be used as, for example, turn indicating means.

Portions of the handle main body 18 corresponding to the light emitting diodes 19a, 19b may be shaped to have lens effect. In this case, the handle main body 18 glows brighter when the light emitting diodes 19a, 19b emit light.

1. An outside door handle for a vehicle, comprising:
a handle main body provided on an outer surface of a vehicle door, the handle main body being formed of a transparent material; and
a light emitting member embedded in the handle main body, wherein electricity required for permitting the light emitting member to emit light is wirelessly supplied from the outside of the handle main body.

2. The outside door handle according to claim 1, further comprising:
a primary coil provided outside of the handle main body, the primary coil functioning as a contactless induction power source; and
a secondary coil embedded in the handle main body, wherein the secondary coil is connected to the light emitting member and is magnetically connectable with the primary coil.

3. The outside door handle according to claim 1, wherein the light emitting member includes a light emitting diode, and wherein the light emitting diode emits light in different manners when the door is locked and when the door is unlocked.

4. The outside door handle according to claim 1, wherein the light emitting member includes a plurality of light emitting diodes of different colors, wherein, when the door is locked, one of the light emitting diodes emits light, and wherein, when the door is unlocked, another one of the light emitting diodes emits light.

5. The outside door handle according to claim 1, wherein the handle main body is movably attached to the door.

6. The outside door handle according to claim 1, wherein the handle main body is immovably attached to the door.
